(19) United States
(12) Patent Application Publication
(10) Pub. No.: US 2025/0292006 A1
(43) Pub. Date: Sep. 18, 2025

(54) Response Generation Based On Conversational Audio

(71) Applicant: Google LLC, Mountain View, CA (US)

(72) Inventors: Mayank Daswani, London (GB); Jing Tang, London (GB); Divya Ramnath, Bangalore (IN); Omar Ismail, London (GB); William Ronald Ito, Mountain View, CA (US); Anchita Goel, Bangalore (IN); Justin Jesada Tansuwan, Los Altos, CA (US)

(21) Appl. No.: 19/075,707

(22) Filed: Mar. 10, 2025

(30) Foreign Application Priority Data
Mar. 14, 2024 (IN) 202441018621

(51) Int. Cl. G06F 40/174; G10L 15/16

(52) U.S. Cl. CPC G06F 40/174; G10L 15/16

(57) ABSTRACT

A method of automatic electronic form population includes generating, at a device, a text transcript of a real-time audio conversation. The method also includes generating, by the device and using a large language model, a response to a particular query on a form based on the text transcript. An indication of the particular query and the text transcript are provided as input prompts to the large language model. The method also includes populating, by the device, a particular field of the form based on the response to the particular query to generate a populated version of the form during the real-time audio conversation. The particular field of the form is associated with the particular query. The method also includes presenting, by the device, the populated version of the form via a user interface.

### CROSS-REFERENCE TO RELATED APPLICATIONS

The present application claims the benefit of Indian patent application Ser. No. 20/244,1018621 filed Mar. 14, 2024. The contents of which are hereby incorporated by reference in their entirety.

### BACKGROUND

Forms can be used to collect information for different purposes. As non-limiting examples, forms can be used to collect demographic information of residents for a census, healthcare information of a patient for a healthcare screening, personal information from a participant of a survey, etc. For the following illustrative example, let's use the example of collecting personal information from the participant of the survey. While there may be different ways to collect information from the participant for filling out the survey, one of the most natural ways to collect the information from the participant is through spoken conversation. For example, a survey conductor can verbally ask the participant questions, and the participant can verbally respond to the questions.

However, collecting information from the participant through spoken conversation may have several drawbacks. For example, if the survey conductor tries to record data (e.g., responses to the questions) during the conversation, the survey conductor may appear distracted to the participant, which can lead to a poor experience that negatively affects data quality. If the survey conductor tries to record the data after the conversation, the survey conductor may not correctly remember all of the information.

### SUMMARY

An audio conversation between a first person attempting to gain information for a form and a second person attempting to provide the information may be captured using one or more microphones of a device. The form can correspond to a census, a healthcare screening form, a survey, etc. In some implementations, the device may generate a text transcript of the captured audio conversation using automatic speech recognition. The device may feed the text transcript of the audio conversation into a large language model along with different queries (e.g., questions) on the form. In some implementations, the device can feed the captured audio directly into the large language model. As used herein, the term “large language model” can include multistage large language models, multimodal large language models, transformer-based large language models, non-transformer-based large language models, or any other type of large language model. In particular, the term “large language model” can correspond to any artificial neural network(s) that learn statistical relationships from text during a computationally intensive training process.

Using the large language model, the device may generate responses to the different queries based on the text transcript and may present the responses to the first person via a user interface. The first person may edit the responses using the user interface. In addition to presenting the responses to the first person, the device may also present, via the user interface, “chain-of-thought” reasoning as to how the large language model determined the responses. Using the chain-of-thought reasoning, the first person may edit the responses using the user interface if the first person believes that the responses are not reflective of the conversation.

In a first example embodiment, a method of automatic electronic form population includes generating, at a device, a text transcript of a real-time audio conversation. The method also includes generating, by the device and using a large language model, a response to a particular query on a form based on the text transcript. An indication of the particular query and the text transcript are provided as input prompts to the large language model. The method also includes populating, by the device, a particular field of the form based on the response to the particular query to generate a populated version of the form during the real-time audio conversation. The particular field of the form is associated with the particular query. The method also includes presenting, by the device, the populated version of the form via a user interface.

In a second example embodiment, a device includes a memory and a processor coupled to the memory. The processor is configured to generate a text transcript of a real-time audio conversation. The processor is also configured to generate, using a large language model, a response to a particular query on a form based on the text transcript. An indication of the particular query and the text transcript are provided as input prompts to the large language model. The processor is also configured to populate a particular field of the form based on the response to the particular query to generate a populated version of the form during the real-time audio conversation. The particular field of the form is associated with the particular query. The processor is also configured to present the populated version of the form via a user interface.

In a third example embodiment, a non-transitory computer-readable medium includes instructions that, when executed by a processor, cause the processor to perform operations. The operations include generating a text transcript of a real-time audio conversation. The operations also include generating, using a large language model, a response to a particular query on a form based on the text transcript. An indication of the particular query and the text transcript are provided as input prompts to the large language model. The operations also include populating a particular field of the form based on the response to the particular query to generate a populated version of the form during the real-time audio conversation. The particular field of the form is associated with the particular query. The operations also include presenting the populated version of the form via a user interface.

In a fourth example embodiment, a system may include various means for carrying out each of the operations of the first example embodiment.

In a fifth example embodiment, a method of form population includes generating, at a device, a text transcript of a real-time audio conversation. The method also includes generating, by the device and using a large language model, a model-based response to a particular query on a form based on the text transcript. An indication of the particular query and the text transcript are provided as input prompts to the large language model. The method also includes receiving, by the device, a user-based response to the particular query on the form. The method also includes determining, by the device, whether the user-based response is consistent with the model-based response. The method also includes presenting, by the device and via a user interface, an indication of whether the user-based response is consistent with the model-based response.

In a sixth example embodiment, a device includes a memory and a processor coupled to the memory. The processor is configured to generate a text transcript of a real-time audio conversation. The processor is also configured to generate, using a large language model, a model-based response to a particular query on a form based on the text transcript. An indication of the particular query and the text transcript are provided as input prompts to the large language model. The processor is also configured to receive a user-based response to the particular query on the form. The processor is also configured to determine whether the user-based response is consistent with the model-based response. The processor is also configured to present, via a user interface, an indication of whether the user-based response is consistent with the model-based response.

In a seventh example embodiment, a non-transitory computer-readable medium includes instructions that, when executed by a processor, cause the processor to perform operations. The operations include generating a text transcript of a real-time audio conversation. The operations also include generating, using a large language model, a model-based response to a particular query on a form based on the text transcript. An indication of the particular query and the text transcript are provided as input prompts to the large language model. The operations also include receiving a user-based response to the particular query on the form. The operations also include determining whether the user-based response is consistent with the model-based response. The operations also include presenting, via a user interface, an indication of whether the user-based response is consistent with the model-based response.

In an eighth example embodiment, a system may include various means for carrying out each of the operations of the fifth example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates an example of a device that populates a form based on a real-time audio conversation, in accordance with examples described herein.

FIG. 2 illustrates an example of a process for generating a response to a query based on a text transcript of a real-time audio conversation, in accordance with examples described herein.

FIG. 3 illustrates an example of a process for modifying a user-based response to a query based on a response generated by a large language model, in accordance with examples described herein.

FIG. 4 illustrates an example of presenting rationale information for a model-based response to a query, in accordance with examples described herein.

FIG. 5 is a diagram illustrating training and inference phases of a machine-learning model, in accordance with examples described herein.

FIG. 6 illustrates a flow chart, in accordance with examples described herein.

FIG. 7 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

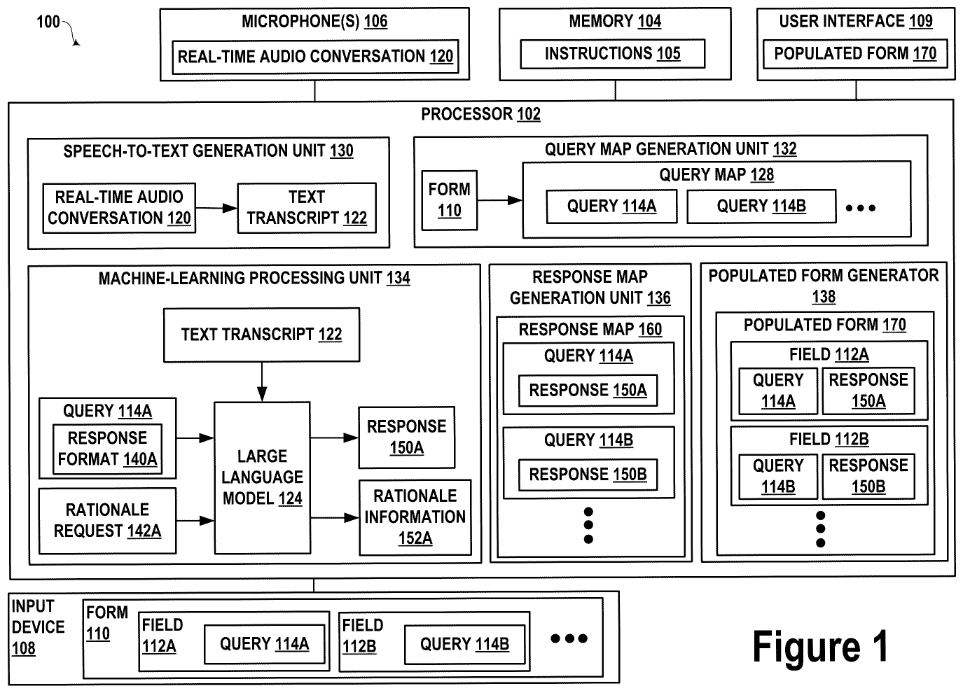

Particular embodiments are described herein with reference to the drawings. In the description, common features are designated by common reference numbers throughout the drawings. In some figures, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple fields are illustrated and associated with reference numbers 112A and 112B. When referring to a particular one of these fields, such as the field 112A, the distinguishing letter “A” is used. However, when referring to any arbitrary one of these fields or to these fields as a group, the reference number 112 is used without a distinguishing letter.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

Different entities (e.g., governments, businesses, individuals, etc.) may depend on collecting information from people for a variety of different purposes, such as for a census, a survey, a healthcare checklist, etc. While there are a variety of ways to collect information from people, one of the most natural ways to collect information may be through spoken conversation with a person (e.g., an information provider).

However, collecting information through spoken conversation may have inherent drawbacks. For example, if a conductor (e.g., the person collecting the information) tries to record data during the spoken conversation, the conductor may appear distracted to the information provider, which may result in a poor experience that can affect the quality of the information collected. As another example, if the conductor attempts to record the data after the spoken conversation, the conductor may not correctly remember all of the information. By collecting information through spoken conversation, the conductor typically has to allocate time and effort for manually entering information onto a form, which reduces the time for direct engagement with the information provider.

The techniques described herein provide a solution to the above-mentioned drawbacks by utilizing a large language model to automate response generation (e.g., answer generation) to different queries (e.g., inquiries) on a form based on a text transcript of the spoken conversation. For example, an audio conversation (e.g., the spoken conversation) between the conductor and the information provider can be captured (e.g., recorded) by a mobile device. In some scenarios, a recording application on the mobile device can be used to record the audio conversation. In some implementations, audio from the audio conversation may be fed into an automatic speech recognition (ASR) system that can generate a text transcript of the audio conversation.

The form (e.g., the questionnaire) that the conductor wants to populate with responses is provided to a processor of the mobile device. For example, the form can be scanned using a camera application of the mobile device, the form can be uploaded to the mobile device, the form can be downloaded by the mobile device, etc. The processor converts the form into a question map of individual queries (e.g., questions or inquiries). As described below, after responses to the questions are generated by the large language model, a response map, that is editable by the conductor, is created.

The text transcript of the audio conversation (or audio from the audio conversation) is fed into the large language model along with each question (in the question map) to be populated by the large language model from the text transcript (or the corresponding audio). For example, for each question in the set of questions, the large language model is prompted with the question and a corresponding response format associated with the question. To illustrate, if the question is a multiple choice question, the large language model is prompted with multiple choice options from which to choose. In some scenarios, depending on the type of question, question and response examples (e.g., multiple choice question and response examples, multi-choice question and response examples, true-false question and response examples, etc.) may be provided to the large language model to ensure that the large language model outputs an accurate result. As indicated above, the large language model is also prompted with the text transcript, or portions of the text transcript, provided by the ASR system. In scenarios where only portions of the text transcript are provided to the large language model, iterations of the text transcript are provided multiple times to ensure that the entire text transcript is provided to the large language model.

Based on the text transcript, the questions, and the response format examples provided to the large language model, the large language model can generate a response to each question on the form. The responses from the large language model can be used to populate the set of questions in the form. For example, the processor can generate a response map that maps responses to each question in the question map. In scenarios where the information needed to respond to a particular question is not found in the text transcript, the large language model can provide a response that indicates the response to the particular question was not found (e.g., a “NOT_FOUND” response).

Based on the response map, a populated form may be generated. For example, the response map (e.g., the responses to the set of questions generated by the large language model) are provided to a user interface and presented to the conductor for review and/or correction. Thus, the conductor can edit the responses to the questions to ensure that the responses are accurate. After the responses in the response map are approved by the conductor, the processor may populate the form based on the response map.

In some embodiments, in response to a prompt, the large language model may provide a rationale (e.g., “chain-of-thought” reasoning) for the responses. To illustrate, the large language model may output a portion of the text transcript that was used to generate specific responses, or the large language model may provide different inferences used to generate specific responses based on the text transcript. The conductor may use the rationale to approve or edit the responses in the response map.

Depending on the implementation, the response map (or the populated form) may be provided to the conductor via the user interface according to different scenarios. According to one scenario, the response map (or the populated form) can be provided to the conductor via the user interface after the spoken conversation between the conductor and the information provided has ended. According to another scenario, the response map (or the populated form) may be streamed to the user interface as the spoken conversation takes place once the processor detects questions are being answered. In this scenario, the conductor is provided with real-time feedback. According to yet another scenario, the conductor can manually populate the form. In this scenario, if the responses manually entered by the conductor are different from the responses generated by the large language model, the processor can provide feedback indicating the difference and provide the rationale for the responses generated by the large language model.

The techniques described above can be applied in different scenarios. As a non-limiting example, according to one scenario, a user may be interested in a particular topic, for which there may be a repository of surveys from sources the user trusts to help advise them on the particular topic. A device loads the survey, reads out questions via machine-generated text, and listens for spoken responses from the user. According to the techniques described above, survey results (e.g., the spoken responses from the user) may be populated by the device without any additional user action, and the user can make corrections to the survey results. In a healthcare context, the device can be associated with a lightweight health risk screener designed to help the user think about whether or not to seek medical advice.

As another non-limiting example, according to one scenario, a healthcare worker may be tasked with collecting information from a patient according to a predetermined survey. Rather than recording responses to the survey by writing the responses on paper and digitizing the responses in a separate process, the healthcare worker may bring a phone that has an application capable of performing the above-described techniques. For example, the healthcare worker may use the application on the phone to record the conversation with the patient. During the conversation, the healthcare worker can see real-time progress of the application populating the survey with responses from the patient. Alternatively, the healthcare worker can review and correct a fully populated survey at the end of the conversation. Although the above example is directed to a healthcare survey, the above-described techniques can also be implemented for populating other surveys (e.g., a census).

As another non-limiting example, according to one scenario, a personal healthcare product may be used to enable users to capture salient aspects of their health. In this scenario, the healthcare product can use the above-described techniques to dictate high-level questions about medication, medical history, allergies, etc. The responses to the questions are captured and populated so that the healthcare product can transform the initially structured information into a more domain-specific structure (e.g., Fast Healthcare Interoperability Resources (FHIR) resources) more suitable for application needs.

### II. Example Device

FIG. 1 illustrates an example of a device 100 that populates a form based on a real-time audio conversation. In some scenarios, the device 100 corresponds to a server. In other scenarios, the device 100 corresponds to a client device. In particular, the device 100 can correspond to any mobile or stationary device that can detect and process audio. As non-limiting examples, the device 100 can be a mobile phone, a personal digital assistant (PDA), a laptop computer, a tablet, etc.

The device 100 includes a processor 102, a memory 104 coupled to the processor 102, one or more microphones 106 coupled to the processor 102, an input device 108 coupled to the processor 102, and a user interface 109 coupled to the processor 102. In some embodiments, the user interface 109 can be integrated into the input device 108. As a non-limiting example, the input device 108 may include a touchscreen display (e.g., the user interface 109) that enables a user associated with the device 100 to interact with displayed content. The memory 104 can correspond to a non-transitory computer-readable medium that includes instructions 105 executable by the processor 102 to perform the operations described herein.

The input device 108 can be configured to provide a form 110 to the processor 102. For example, in some scenarios, the input device 108 can correspond to a scanner or a camera that can generate an image of the form 110 and provide the image of the form 110 to the processor 102. In these scenarios, the processor 102 can perform an image-to-text conversion operation, such as an optical character recognition (OCR) operation, on the image of the form 110 to generate an electronic version of the form 110 that is usable by the processor 102. In other scenarios, the input device 108 can correspond to a memory device that stores an electronic version of the form 110. As a non-limiting example, the input device 108 can correspond to a universal serial bus (USB) drive that stores an electronic version of the form 110 and provides (e.g., uploads) the electronic version of the form 110 to the processor 102. In some scenarios, the form 110 can be provided to the processor 102 via a downloading process. For example, the processor 102 can download the form 110 from the internet or from another third-party source.

The form 110 can be used to collect different information. As non-limiting examples, the form 110 can be used to collect demographic information of residents for a census, healthcare information of a patient for a healthcare screening, personal information from a participant of a survey, etc. The form 110 can include a plurality of different fields 112. As illustrated in FIG. 1, the form 110 can include a field 112A and a field 112B. Although two fields 112 are illustrated, in other scenarios, the form 110 can include additional (or fewer) fields. As a non-limiting example, in some scenarios, the form 110 can include forty (40) different fields. As another non-limiting example, in some scenarios, the form 110 can include a single field. As used herein, each field 112 of the form 110 corresponds to a section of the form 110 that includes a corresponding query 114. For example, the field 112A includes a query 114A, and the field 112B includes a query 114B. As described below, the device 100 can generate responses 150 (e.g., answers) to the queries 114 (e.g., inquiries) by applying a text transcript 122 of a real-time audio conversation 120 to a large language model 124.

The processor 102 includes a speech-to-text generation unit 130, a query map generation unit 132, a machine-learning processing unit 134, a response map generation unit 136, and a populated form generator 138. According to some embodiments, one or more components of the processor 102 can be implemented using dedicated hardware. As a non-limiting example, one or more components of the processor 102 can be implemented using one or more application-specific integrated circuits (ASICs) or one or more field programmable gate array (FPGA) devices. According to some embodiments, one or more components of the processor 102 can be implemented using software or firmware. As a non-limiting example, one or more components of the processor 102 can be implemented by the processor 102 executing the instructions 105 stored in the memory 104.

The query map generation unit 132 may be configured to convert the form 110 into a query map 128 that includes each query 114A, 114B in the form 110. For example, the query map 128 may include the query 114A, the query 114B, and any other query in the form 110. In some scenarios, to convert the form 110 into the query map 128, the query map generation unit 132 may perform optical character recognition (OCR) to identify different queries 114 in the form 110.

The one or more microphones 106 can be configured to detect (e.g., capture) a real-time audio conversation 120. The real-time audio conversation 120 can be associated with the different queries 114 on the form 110. As a non-limiting example, a user associated with the device 100 (e.g., a person collecting information) can engage in a conversation 120 with a third-party (e.g., an information provider). During the conversation 120, the user associated with the device 100 can illicit responses to different queries 114 on the form 110. To illicit responses to the queries 114, the user associated with the device 100 does not necessarily have to read the queries 114 from the form 110. Rather, the user associated with the device 100 can make statements or ask vague questions that illicit responses to the queries 114. As a non-limiting example, if the form 110 is a healthcare form used to collect patient information, the query 114A can state “List all health conditions that you have been diagnosed with over the past ten years.” In this example, during the conversation 120, the user associated with the device 100 can state, to the third-party, “Tell me about your history of illnesses.” In response to this statement, the third-party may divulge information that is pertinent to the query 114A.

The speech-to-text generation unit 130 may be configured to generate a text transcript 122 of the real-time audio conversation 120. To generate the text transcript 122 of the real-time audio conversation 120, the speech-to-text generation unit 130 may perform an automatic speech recognition (ASR) operation on the real-time audio conversation 120. Thus, during the conversation 120 between the user associated with the device 100 and the third-party, the speech-to-text generation unit 130 can generate the text transcript 122 such that the text transcript 122 includes speech from the user associated with the device 100 and speech from the third-party.

The machine-learning processing unit 134 may be configured to generate, using a large language model 124, a response 150 to each query 114 on the form 110 based on the text transcript 122 of the real-time audio conversation 120. For example, using the large language model 124, the machine-learning processing unit 134 can generate a response 150A to the query 114A and can generate a response 150B to the query 114B. For ease of description, the following example describes generating the response 150A to the query 114A, as depicted in FIG. 1. However, it should be understood that responses 150 to other queries 114, such as the response 150B to the query 114B, can be generated in a substantially similar manner.

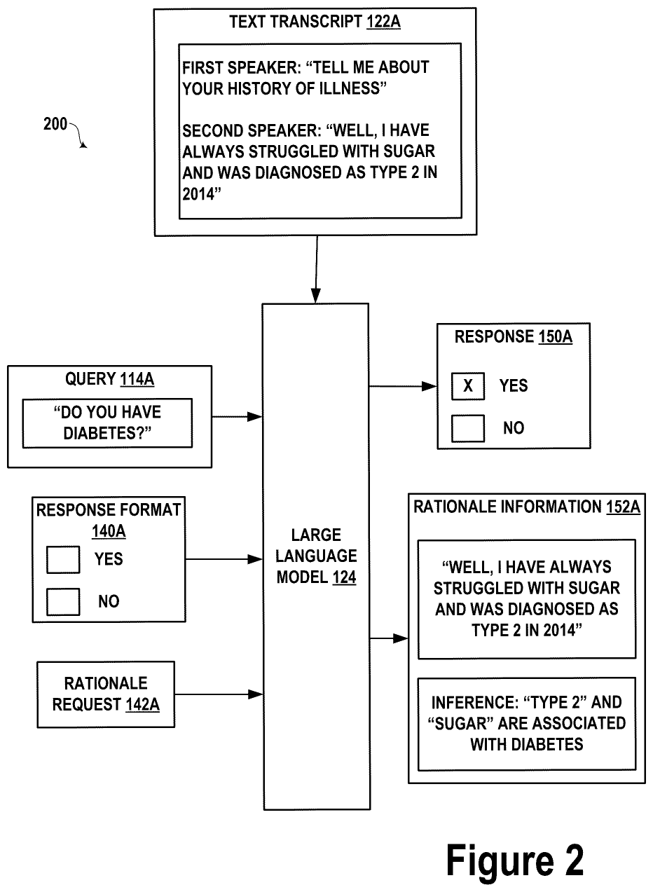

As depicted in FIG. 1, an indication of the query 114A and the text transcript 122 are provided as input prompts to the large language model 124. In some scenarios, audio from the real-time audio conversation 120, as opposed to the text transcript 122, is provided as an input prompt to the large language model 124. In some scenarios, as depicted in FIG. 1, a response format 140A of the query 114A is also provided to the large language model 124 as an input prompt. The response format 140A can correspond to a true-false format, a multiple choice format, a fill-in-the-blank format, etc. When the query 114A and the corresponding response format 140A of the query 114A is provided to the large language model 124, the machine-learning processing unit 134 can generate the response 150A to the query 114A (according to the response format 140A), using the large language model 124, based on the text transcript 122 of the real-time audio conversation 120. For example, as described in greater detail with respect to FIG. 2, the large language model 124 can generate the response 150A based on the text transcript 122 or based on inferences from the text transcript 122 (e.g., inferences from the responses given by the third-party during the real-time audio conversation).

In some scenarios, a rationale request 142A for the response 150A to the query 114A is provided as an input prompt to the large language model 124. Based on the rationale request 142A and the text transcript 122 of the real-time audio conversation, the machine-learning processing unit 134 may be configured to generate rationale information 152A that indicates a rationale (e.g., “chain-of-thought” reasoning) for the response 150A to the query 114A. For example, in some scenarios, as illustrated in FIG. 2, the rationale information 152A includes a portion of the text transcript 122 from which the response 150A to the query 114A was generated. In some scenarios, as illustrated in FIG. 2, the rationale information 152A includes one or more inferences from the large language model 124 used to generate the response 150A to the query 114A based on the text transcript 122.

The response map generation unit 136 may be configured to generate a response map 160 that includes responses 150 to corresponding queries 114 in the query map 128. For example, after the machine-learning processing unit 134 generates the responses 150A, 150B to the queries 114A, 114B, respectively, the response map generation unit 136 can generate the response map 160 that maps the responses 150A, 150B to the respective queries 114A, 114B. In some scenarios, the responses 150A, 150B in the response map 160 are provided to the user interface 109 and presented to the user associated with the device 100 for review and/or correction. Thus, the user associated with the device 100 can edit the responses 150A, 150B to the queries 114A, 114B, respectively, to ensure that the responses 150A, 150B are accurate. Based on the response map 160, a populated form 170 may be generated.

For example, the populated form generator 138 may be configured to populate the different fields 112 on the form 110 based on the responses 150 to the respective queries 114 to generate the populated form 170 (e.g., a populated version of the form 110) during the real-time audio conversation 120. For example, during the real-time audio conversation 120, the populated form generator 138 may populate the field 112A based on the response 150A to the query 114A and may populate the field 112B based on the response 150B to the query 114B. Populating the field 112A of the form 110 corresponds to providing the response 150A to the query 114A according to the response format 140A.

In some scenarios, the processor 102 may be configured to present the populated form 170 via the user interface 109. The populated form 170 may be editable, via the user interface 109, to enable user edits to the responses 150. For example, the user associated with the device 100 may edit (e.g., change) the responses 150 generated by the machine-learning processing unit 134 using the user interface 109. In some scenarios, the processor 102 may be configured to present the rationale information 152A via the user interface 109. In these scenarios, the user associated with the device 100 can identify the rationale for the response 150A and use the user interface 109 to edit the response 150A if the user disagrees with the rationale. According to one implementation, the response 150A (e.g., a model-based response) has a link to the rationale information 152A on the user interface 109.

Thus, the device 100 of FIG. 1 enables the queries 114 of the form 110 to be populated with responses 150 in real-time based on the text transcript 122 of the real-time audio conversation 120. For example, the large language model 124 can be used to generate responses 150 to the queries 114 without manual input from the user associated with the device 100. As a result, the user associated with the device 100 can focus on the information provider during the real-time audio conversation 120, as opposed to focusing on filling out the form 110.

### III. Example Processes

FIG. 2 illustrates an example of a process 200 for generating a response to a query based on a text transcript of a real-time audio conversation. The process 200 can be performed by the device 100 of FIG. 1. More specifically, the process 200 can be performed by the machine-learning processing unit 134 of the processor 102.

According to the process 200, a portion of the text transcript 122A is provided to the large language model 124. In FIG. 2, the portion of the text transcript 122A includes a textual version of a statement from a first speaker (e.g., the user associated with the device 100) that says “Tell me about your history of illness.” The portion of the text transcript 122A also includes a textual version of a statement from a second speaker (e.g., the information provider) that says “Well, I have always struggled with sugar and was diagnosed as Type 2 in 2014.”

According to the process 200, the query 114A is also provided to the large language model 124. In the example of FIG. 2, the query 114A states “Do you have diabetes?” The response format 140A for the query 114A is also provided to the large language model 124. In the example of FIG. 2, the response format 140A indicates that the response 150A to the query 114A is either “yes” or “no”. Additionally, the response format 140A indicates that in order to populate the query 114A, a box next to the “yes” option or a box next to the “no” option needs to be filled in (e.g., marked with an “X”).

According to the process 200, the machine-learning processing unit 134 can generate the response 150A to the query 114A (according to the response format 140A), using the large language model 124, based on the portion of the text transcript 122A of the real-time audio conversation 120 and/or inferences from the portion of the text transcript 122A. In FIG. 2, the response 150A to the query 114A is “yes” and is depicted by marking an “X” in the box next to the “yes” option.

As illustrated in FIG. 2, the rationale request 142A for the response 150A to the query 114A is provided as an input prompt to the large language model 124. Based on the rationale request 142A and the text transcript 122 of the real-time audio conversation, the machine-learning processing unit 134 may be configured to generate the rationale information 152A that indicates a rationale (e.g., “chain-of-thought” reasoning) for the response 150A to the query 114A. As depicted in FIG. 2, the rationale information 152A includes the portion of the text transcript 122A where the second speaker states “Well, I have always struggled with sugar and was diagnosed as Type 2 in 2014.” The rationale information 152A also includes the inference that the phrases “Type 2” and “Sugar” from the portion of the text transcript 122a are associated with diabetes.

As described above, the rationale information 152A can be presented via the user interface 109. In these scenarios, the user associated with the device 100 can identify the rationale for the response 150A and use the user interface 109 to edit the response 150A if the user disagrees with the rationale.

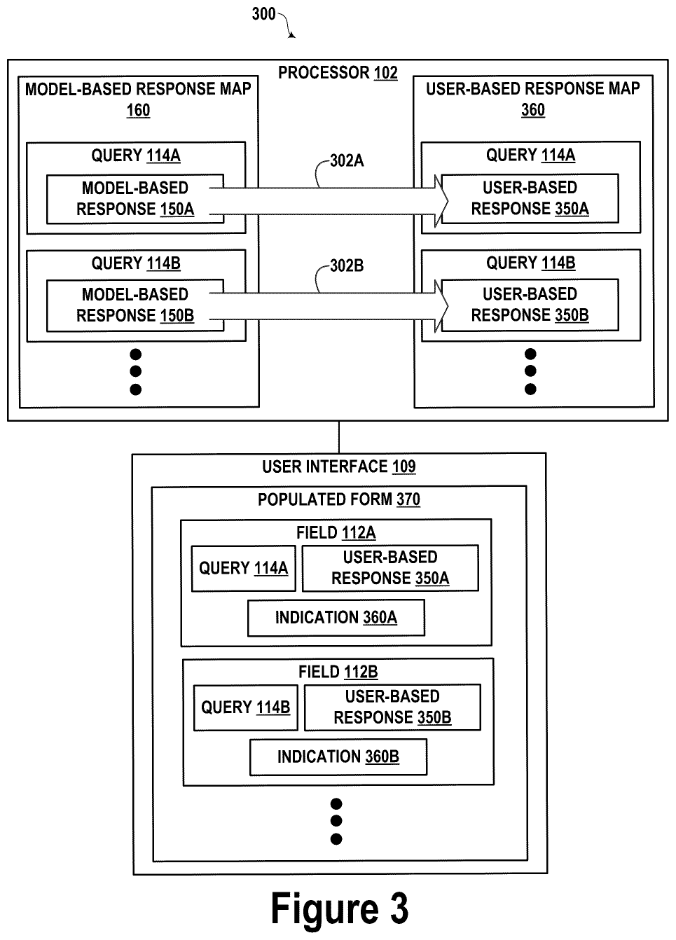

FIG. 3 illustrates an example of a process 300 for modifying a user-based response to a query based on a response generated by a large language model. The process 300 can be performed by the device 100 of FIG. 1. More specifically, the process 300 can be performed by the processor 102 and the user interface 109.

According to the process 300, the processor 102 (e.g., the machine-learning processing unit 134) can generate the response 150A (e.g., a “model-based response” from the large language model 124) to the query 114A based on the portion of the text transcript 122A of the real-time audio conversation 120 and/or inferences from the portion of the text transcript 122A, as described in FIG. 2. For example, as described in FIG. 2, the model-based response 150A to the query 114A is “yes” and is depicted by marking an “X” in the box next to the “yes” option. In a similar manner, the processor 102 can generate, using the large language model 124, the model-based response 150B to the query 114B based on the text transcript 122 of the real-time audio conversation 120 and/or inferences from the text transcript 122. The model-based responses 150A, 150B can be used to generate a model-based response map 160, as described with respect to FIG. 1.

However, instead of populating the form 110 based on the model-based response map 160, in some scenarios, the user associated with the device 100 can use the user interface 109 to input user-based responses 350 to the different queries 114. For example, during (or after) the audio conversation 120, the user associated with the device 100 can use the user interface 109 to personally fill out the form 110 (e.g., provide a response 350A to the query 114A and provide a response 350B to the query 114B). In these scenarios, the user-based responses 350A, 350B can be inserted into a user-based response map 360, as depicted in FIG. 3.

The processor 102 may be configured to determine whether the user-based responses 350A, 350B are consistent with the corresponding model-based responses 150A, 150B. To illustrate, the processor 102 may perform a comparison operation 302A on the model-based response 150A and the corresponding user-based response 350A to ensure that the responses 150A, 350A are consistent, and the processor 102 may perform a comparison operation 302B on the model-based response 150B and the corresponding user-based response 350B to ensure that the responses 150B, 350B are consistent.

The processor 102 can generate a populated form 370 based on the user-based responses 350A, 350B. In some implementations, the populated form 370 corresponds to the populated form 170 of FIG. 1. The populated form 370 includes an indication 360A of whether the user-based response 350A is consistent with the corresponding model-based response 150A and an indication 360B of whether the user-based response 350B is consistent with the corresponding model-based response 150B.

To illustrate, if the user-based response 350A to the query 114A is “no” and is depicted by marking an “X” in the box next to the “no” option, during the comparison operation 302A, the processor 102 may determine that the user-based response 350A is not consistent with the model-based response 150A because, as described in FIG. 2, the model-based response 150A to the query 114A is “yes”. As a result, the processor 102 may present, via the user interface 109, the indication 360A that the user-based response 350A is inconsistent with the model-based response 150A. A similar process can be performed with respect to the indication 360B for the responses 150B, 350B. For ease of description, let's assume that the user-based response 350B is consistent with the model-based response 150B.

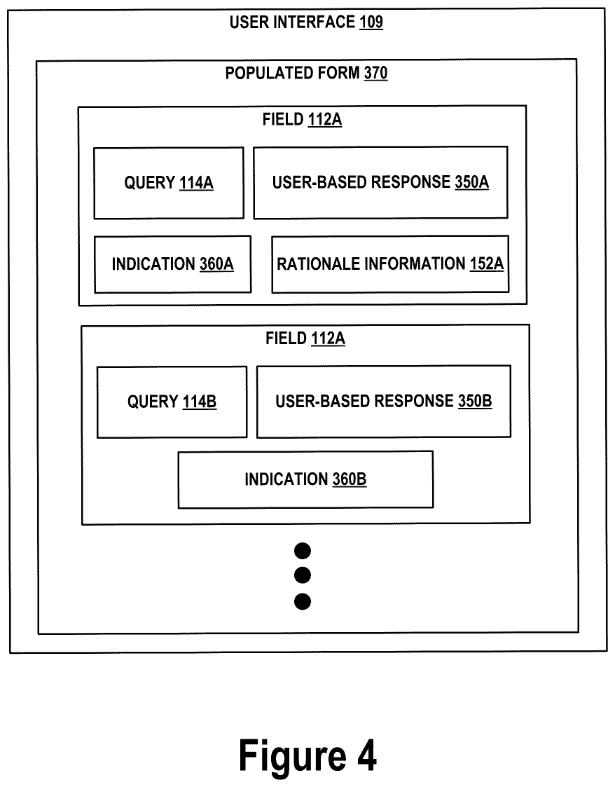

As illustrated in FIG. 4, the processor 102 may be configured to present the rationale information 152A via the user interface 109 in response to a determination that the user-based response 350A is not consistent with the model-based response 150A. Thus, the user associated with the device 100 can use the rationale information 152A for the model-based response 150A to determine whether to modify the user-based response 350A based on the model-based response 150A.

The techniques described with respect to FIGS. 3-4 provide additional assurance to responses 350 to the queries provided by a user. For example, if the user associated with the device 100 provides responses 350 to the queries 114 on the form 110 based on the user's recollection of the conversation 120, the accuracy of the user's responses 350 is determined based on the model-based responses 150 generated using the large language model 124. Any inconsistencies between the responses 150 generated using the large language model 124 and the user's responses 350 can be resolved by the user based on the rationale information 152 used to generate the responses 150 generated using the large language model 124. For example, the user can review the rationale information 152 and determine whether to change the user's responses 350 to reflect the model-based responses 150.

### IV. Example Machine-Learning Process For Large Language Models

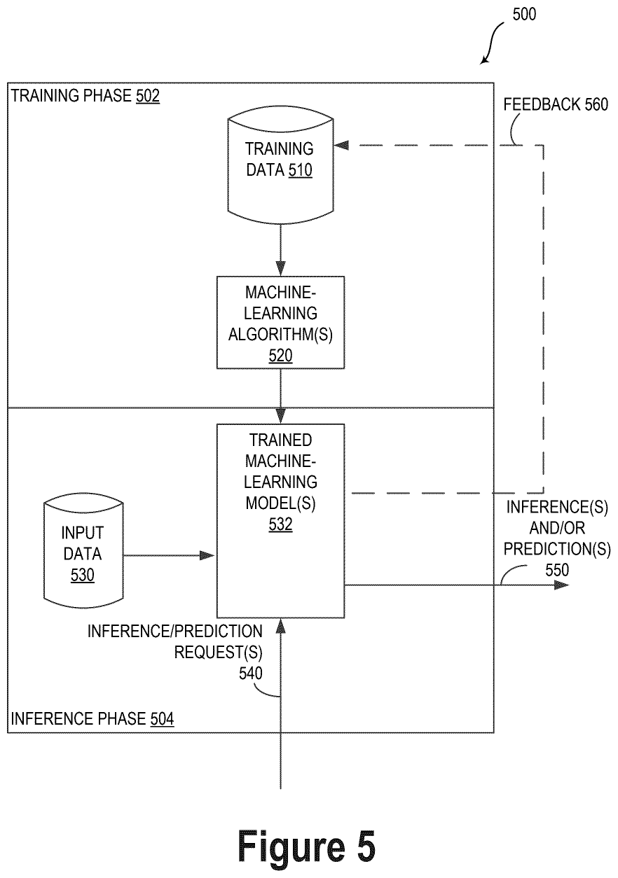

FIG. 5 shows a diagram 500 illustrating a training phase 502 and an inference phase 504 of trained machine-learning model(s) 532, in accordance with example embodiments. According to some examples, the trained machine-learning model(s) 532 can correspond to the large language model 124. Some machine-learning techniques involve training one or more machine-learning algorithms on an input set of training data to recognize patterns in the training data and provide output inferences and/or predictions about (patterns in the) training data. The resulting trained machine-learning algorithm can be termed as a trained machine-learning model. For example, FIG. 5 shows the training phase 502 where machine-learning algorithm(s) 520 are being trained on training data 510 to become trained machine-learning model(s) 532. Then, during the inference phase 504, the trained machine-learning model(s) 532 can receive input data 530 and one or more inference/prediction requests 540 (perhaps as part of the input data 530) and responsively provide as an output one or more inferences and/or prediction(s) 550.

As such, the trained machine-learning model(s) 532 can include one or more models of machine-learning algorithm(s) 520. The machine-learning algorithm(s) 520 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine-learning algorithm, and/or a heuristic machine-learning system). The machine-learning algorithm(s) 520 may be supervised or unsupervised, and may implement any suitable combination of online and offline learning.

In some examples, the machine-learning algorithm(s) 520 and/or the trained machine-learning model(s) 532 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up the machine-learning algorithm(s) 520 and/or the trained machine-learning model(s) 532. In some examples, the trained machine-learning model(s) 532 can be trained, stored and executed to provide inferences on a particular computing device, and/or otherwise can make inferences for the particular computing device.

During the training phase 502, the machine-learning algorithm(s) 520 can be trained by providing at least the training data 510 as training input using unsupervised, supervised, semi-supervised, and/or reinforcement learning techniques. Unsupervised learning involves providing a portion (or all) of the training data 510 to the machine-learning algorithm(s) 520 and the machine-learning algorithm(s) 520 determining one or more output inferences based on the provided portion (or all) of the training data 510. Supervised learning involves providing a portion of the training data 510 to the machine-learning algorithm(s) 520, with the machine-learning algorithm(s) 520 determining one or more output inferences based on the provided portion of the training data 510, and the output inference(s) are either accepted or corrected based on correct results associated with the training data 510. In some examples, supervised learning of the machine-learning algorithm(s) 520 can be governed by a set of rules and/or a set of labels for the training input, and the set of rules and/or set of labels may be used to correct inferences of the machine-learning algorithm(s) 520.

Semi-supervised learning involves having correct results for part, but not all, of the training data 510. During semi-supervised learning, supervised learning is used for a portion of the training data 510 having correct results, and unsupervised learning is used for a portion of the training data 510 not having correct results. Reinforcement learning involves the machine-learning algorithm(s) 520 receiving a reward signal regarding a prior inference, where the reward signal can be a numerical value. During reinforcement learning, the machine-learning algorithm(s) 520 can output an inference and receive a reward signal in response, where the machine-learning algorithm(s) 520 are configured to try to maximize the numerical value of the reward signal. In some examples, reinforcement learning also utilizes a value function that provides a numerical value representing an expected total of the numerical values provided by the reward signal over time. In some examples, the machine-learning algorithm(s) 520 and/or the trained machine-learning model(s) 532 can be trained using other machine-learning techniques, including but not limited to, incremental learning and curriculum learning.

In some examples, the machine-learning algorithm(s) 520 and/or the trained machine-learning model(s) 532 can use transfer learning techniques. For example, transfer learning techniques can involve the trained machine-learning model(s) 532 being pre-trained on one set of data and additionally trained using the training data 510. More particularly, the machine-learning algorithm(s) 520 can be pre-trained on data from one or more computing devices and a resulting trained machine-learning model provided to a particular computing device, where the particular computing device is intended to execute the trained machine-learning model during the inference phase 504. Then, during the training phase 502, the pre-trained machine-learning model can be additionally trained using the training data 510, where the training data 510 can be derived from kernel and non-kernel data of the particular computing device. This further training of the machine-learning algorithm(s) 520 and/or the pre-trained machine-learning model using the training data 510 of the particular computing device's data can be performed using either supervised or unsupervised learning. Once the machine-learning algorithm(s) 520 and/or the pre-trained machine-learning model has been trained on at least the training data 510, the training phase 502 can be completed. The trained resulting machine-learning model can be utilized as at least one of the trained machine-learning model(s) 532.

In particular, once the training phase 502 has been completed, the trained machine-learning model(s) 532 can be provided to a computing device, if not already on the computing device. The inference phase 504 can begin after training the machine-learning model(s) 532 are provided to the particular computing device.

During the inference phase 504, the trained machine-learning model(s) 532 can receive the input data 530 and generate and output one or more corresponding inferences and/or prediction(s) 550 about the input data 530. As such, the input data 530 can be used as an input to the trained machine-learning model(s) 532 for providing corresponding inference(s) and/or prediction(s) 550 to kernel components and non-kernel components. For example, the trained machine-learning model(s) 532 can generate inference(s) and/or prediction(s) 550 in response to one or more inference/prediction requests 540. In some examples, the trained machine-learning model(s) 532 can be executed by a portion of other software. For example, the trained machine-learning model(s) 532 can be executed by an inference or prediction daemon to be readily available to provide inferences and/or predictions upon request. The input data 530 can include data from the particular computing device executing the trained machine-learning model(s) 532 and/or input data from one or more computing devices other than the particular computing device.

If the trained machine-learning model 532 corresponds to the large language model 124, the input data 530 can include data associated with different queries 114. Other types of input data are possible as well. Inference(s) and/or prediction(s) 550 can include other output data produced by the trained machine-learning model(s) 532 operating on the input data 530 (and the training data 510). In some examples, the trained machine-learning model(s) 532 can use output inference(s) and/or prediction(s) 550 as input feedback 560. The trained machine-learning model(s) 532 can also rely on past inferences as inputs for generating new inferences.

Transformer-based neural networks and/or deep neural networks used herein can be an example of the machine-learning algorithm(s) 520. After training, the trained version of a convolutional neural network can be an example of the trained machine-learning model(s) 532. In this approach, an example of the one or more inference/prediction requests 540 can be a request to predict a response 150 to a query 114.

### V. Additional Example Operations

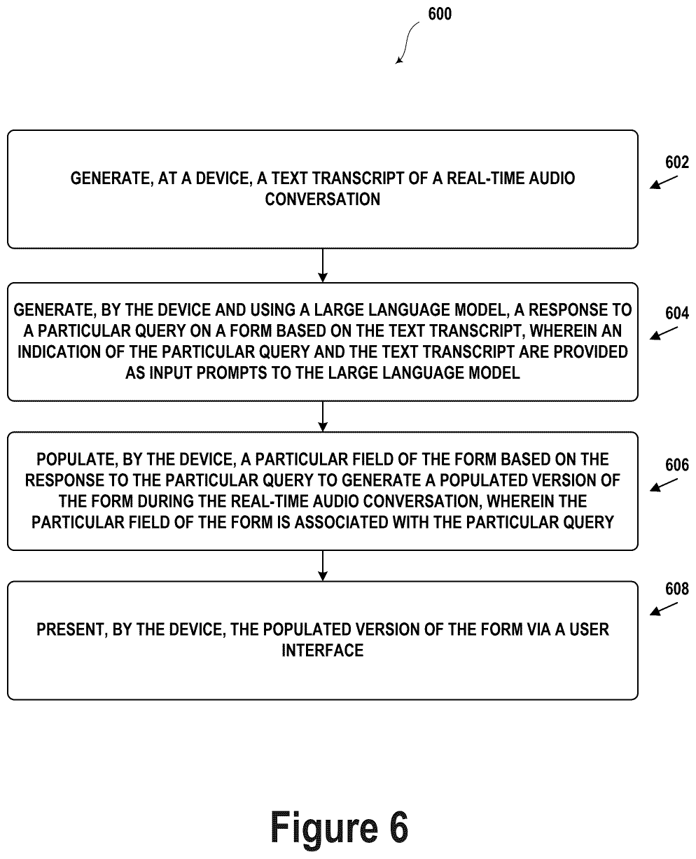

FIG. 6 illustrates a flow chart of a method 600 related to a new technology. The method 600 may be carried out by the device 100 among other possibilities. The embodiments of FIG. 6 may be simplified by the removal of any one or more of the features shown therein. Further, these embodiments may be combined with features, aspects, and/or implementations of any of the previous figures or otherwise described herein.

The method 600 includes generating, at a device, a text transcript of a real-time audio conversation, at block 602. For example, referring to FIG. 1, the speech-to-text generation unit 130 generates the text transcript 122 of the real-time audio conversation 120. According to one implementation of the method 600, generating the text transcript 122 includes performing an automatic speech recognition operation on the real-time audio conversation 120.

The method 600 also includes generating, by the device and using a large language model, a response to a particular query on a form based on the text transcript, at block 604. An indication of the particular query and the text transcript are provided as input prompts to the large language model. For example, referring to FIG. 1, the machine-learning processing unit 134 generates, using the large language model 124, the response 150A to the query 114A on the form 110 based on the text transcript 122. The indication of the query 114A and the text transcript 122 are provided as input prompts to the large language model 124.

The method 600 also includes populating, by the device, a particular field of the form based on the response to the particular query to generate a populated version of the form during the real-time audio conversation, at block 606. The particular field of the form is associated with the particular query. For example, referring to FIG. 1, the populated form generator 138 populates the field 112A of the form 110 based on the response 150A to the query 114A to generate the populated form 170 during the real-time audio conversation 120. The field 112A of the form 110 is associated with the query 114A.

The method 600 also includes presenting, by the device, the populated version of the form via a user interface, at block 608. For example, referring to FIG. 1, the processor 102 presents the populated form 170 via the user interface 109. According to one implementation of the method 600, the populated version of the form (e.g., the populated form 170) is editable, via the user interface 109, to enable user edit to the response 150A in the field 112A.

According to one implementation, the method 600 may include providing, to the large language model as an input prompt, a rationale request for the response to the particular query. For example, referring to FIG. 1, the machine-learning processing unit 134 provides, the large language model 124 as an input prompt, the rationale request 142A for the responses 150A to the query 114A. The method 600 may also include generating, by the device and using the large language model, rationale information that indicates a rationale for the response to the particular query in response to receiving the rationale request. For example, referring to FIG. 1, the machine-learning processing unit 134 generates, using the large language model 124, the rationale information 152A that indicates the rationale (e.g., the “chain-of-thought” reasoning) for the response 150A to the query 114A in response to receiving the rationale request 142A. The method 600 may also include presenting, by the device, the rationale information via the user interface. For example, the processor 102 may also present the rationale information 152A via the user interface 109. According to some implementations of the method 600, the rationale information 152A includes a particular portion of the text transcript 122, one or more inferences from the large language model 124 based on the text transcript 122, or both.

According to one implementation, the method 600 may include providing, to the large language model as an input prompt, a response format of the particular query. Populating the particular field of the form corresponds to providing the response to the particular query according to the response format. For example, referring to FIG. 1, the machine-learning processing unit 134 provides, to the large language model 124 as an input prompt, the response format 140A of the query 114A. Populating the field 112A of the form 110 corresponds to providing the response 150A to the query 114A according to the response format 140A. According to one implementation of the method 600, the response format 140A corresponds to a true-false format. According to one implementation of the method 600, the response format 140A corresponds to a multiple choice format. In other implementations of the method 600, the response format 140A can correspond to a fill-in-the-blank format, and multi-choice format, etc.

According to one implementation of the method 600, in response to the large language model 124 failing to determine a valid response to the particular query 114A, the response 150A to the particular query 114A includes an indication that no valid response was found in the text transcript 122.

According to one implementation, prior to populating the particular field of the form, the method 600 may include converting the form into a query map including a plurality of queries. The particular query is included in the plurality of queries. For example, referring to FIG. 1, the query map generation unit 132 coverts the form 110 into the query map 128. The query map 128 includes a plurality of queries 114A, 114B. The method 600 may also include generating a response map including responses to corresponding queries in the query map. The response to the particular query is included in the response map. For example, referring to FIG. 1, the response map generation unit 136 generates the response map 160 that includes responses 150A, 150B to corresponding queries 114A, 114B in the query map 128. The form 110 may be populated based on the response map 160.

According to one implementation of the method 600, each field 112 of the form 110 is populated after generation of the response map 160 is complete. According to one implementation of the method 600, the particular field 111A of the form 110 is populated as the response 150A is generated. According to one implementation of the method 600, the form 110 corresponds to a survey, a health screening form, or a census.

The method 600 of FIG. 6 enables the queries 114 of the form 110 to be populated with responses 150 in real-time based on the text transcript 122 of the real-time audio conversation 120. For example, the large language model 124 can be used to generate responses 150 to the queries 114 without manual input from the user associated with the device 100. As a result, the user associated with the device 100 can focus on the information provider during the real-time audio conversation, as opposed to focusing on filling out the form 110.

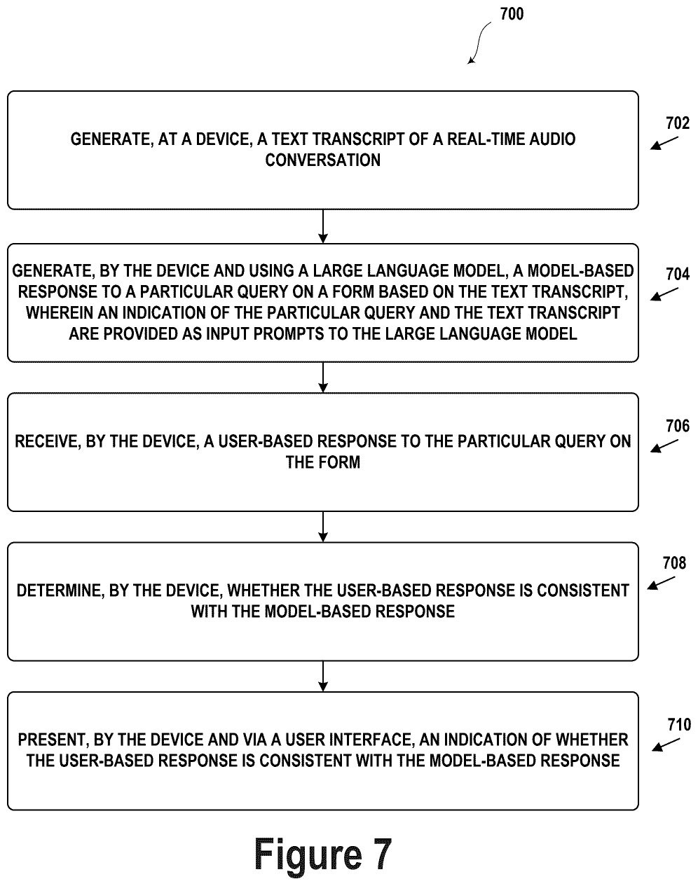

FIG. 7 illustrates a flow chart of a method 700 related to a new technology. The method 700 may be carried out by the device 100 among other possibilities. The embodiments of FIG. 7 may be simplified by the removal of any one or more of the features shown therein. Further, these embodiments may be combined with features, aspects, and/or implementations of any of the previous figures or otherwise described herein.

The method 700 includes generating, at a device, a text transcript of a real-time audio conversation, at block 702. For example, referring to FIG. 1, the speech-to-text generation unit 130 generates the text transcript 122 of the real-time audio conversation 120. According to one implementation of the method 600, generating the text transcript 122 includes performing an automatic speech recognition operation on the real-time audio conversation 120.

The method 700 also includes generating, by the device and using a large language model, a model-based response to a particular query on a form based on the text transcript, at block 704. An indication of the particular query and the text transcript are provided as input prompts to the large language model. For example, referring to FIG. 1, the machine-learning processing unit 134 generates, using the large language model 124, the response 150A to the query 114A on the form 110 based on the text transcript 122. The indication of the query 114A and the text transcript 122 are provided as input prompts to the large language model 124.

The method 700 also includes receiving, by the device, a user-based response to the particular query on the form, at block 706. For example, referring to FIG. 3, the processor 102 receives the user-based response 350A to the query 114A on the form 110. To illustrate, during (or after) the audio conversation 120, the user associated with the device 100 can use the user interface 109 to provide the user-based response 350A to the query 114A.

The method 700 also includes determining, by the device, whether the user-based response is consistent with the model-based response, at block 708. For example, referring to FIG. 3, the processor 102 performs the comparison operation 302A on the model-based response 150A and the corresponding user-based response 350A to determine whether the responses 150A, 350A are consistent.

The method 700 also includes presenting, by the device and via a user interface, an indication of whether the user-based response is consistent with the model-based response, at block 710. For example, referring to FIG. 3, the processor 102 presents, via the user interface 109, the indication 360A of whether the user-based response 350A is consistent with the model-based response 150A.

According to one implementation, the method 700 may include providing, to the large language model as an input prompt, a rationale request for the model-based response to the particular query. For example, referring to FIG. 1, the machine-learning processing unit 134 provides, the large language model 124 as an input prompt, the rationale request 142A for the responses 150A to the query 114A. The method 700 may also include generating, by the device and using the large language model, rationale information that indicates a rationale for the model-based response to the particular query in response to receiving the rationale request. For example, referring to FIG. 1, the machine-learning processing unit 134 generates, using the large language model 124, the rationale information 152A that indicates the rationale (e.g., the “chain-of-thought” reasoning) for the model-based response 150A to the query 114A in response to receiving the rationale request 142A. The method 700 may also include presenting, by the device, the rationale information via the user interface in response to a determination that the user-based response is not consistent with the model-based response. For example, referring to FIG. 4, the rationale information 152A is presented via the user interface 109 in response to the determination that the user-based response 350A is not consistent with the model-based response 150A. According to one implementation of the method 700, the model-based response has a link to the rationale information on the user interface.

The method 700 of FIG. 7 provides additional assurance to responses 350 to the queries provided by a user. For example, if the user associated with the device 100 provides responses 350 to the queries 114 on the form 110 based on the user's recollection of the conversation 120, the accuracy of the user's responses 350 is determined based on the model-based responses 150 generated using the large language model 124. Any inconsistencies between the responses 150 generated using the large language model 124 and the user's responses 350 can be resolved by the user based on the rationale information 152 used to generate the responses 150 generated using the large language model 124. For example, the user can review the rationale information 152 and determine whether to change the user's responses 350 to reflect the model-based responses 150.

### VI. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method of automatic electronic form population, the method comprising:
generating, at a device, a text transcript of a real-time audio conversation;
generating, by the device and using a large language model, a response to a particular query on a form based on the text transcript, wherein an indication of the particular query and the text transcript are provided as input prompts to the large language model;
populating, by the device, a particular field of the form based on the response to the particular query to generate a populated version of the form during the real-time audio conversation, wherein the particular field of the form is associated with the particular query; and
presenting, by the device, the populated version of the form via a user interface.

2. The method of claim 1, further comprising:
providing, to the large language model as an input prompt, a rationale request for the response to the particular query;
generating, by the device and using the large language model, rationale information that indicates a rationale for the response to the particular query in response to receiving the rationale request; and
presenting, by the device, the rationale information via the user interface.

3. The method of claim 2, wherein the rationale information comprises a particular portion of the text transcript, one or more inferences from the large language model based on the text transcript, or both.

4. The method of claim 1, wherein the populated version of the form is editable, via the user interface, to enable user edits to the response in the particular field.

5. The method of claim 1, further comprising:
providing, to the large language model as an input prompt, a response format of the particular query, wherein populating the particular field of the form corresponds to providing the response to the particular query according to the response format.

6. The method of claim 5, wherein the response format corresponds to a true-false format.

7. The method of claim 5, wherein the response format corresponds to a multiple choice format.

8. The method of claim 1, wherein, in response to the large language model failing to determine a valid response to the particular query, the response to the particular query includes an indication that no valid response was found in the text transcript.

9. The method of claim 1, wherein the device corresponds to a client device or a server.

10. The method of claim 1, wherein generating the text transcript comprises performing an automatic speech recognition operation on the real-time audio conversation.

11. The method of claim 1, wherein, prior to populating the particular field of the form, the method comprises:
converting the form into an query map comprising a plurality of queries, wherein the particular query is included in the plurality of queries; and
generating a response map comprising responses to corresponding queries in the query map, wherein the response to the particular query is included in the response map,
wherein the form is populated based on the response map.

12. The method of claim 11, wherein each field of the form is populated after generation of the response map is complete.

13. The method of claim 11, wherein the particular field of the form is populated as the response is generated.

14. The method of claim 1, wherein the form corresponds to a survey, a health screening form, or a census.

15. A device comprising:
a memory; and
a processor coupled to the memory, the processor configured to:
generate a text transcript of a real-time audio conversation;
generate, using a large language model, a response to a particular query on a form based on the text transcript, wherein an indication of the particular query and the text transcript are provided as input prompts to the large language model;
populate a particular field of the form based on the response to the particular query to generate a populated version of the form during the real-time audio conversation, wherein the particular field of the form is associated with the particular query; and
present the populated version of the form via a user interface.

16. The device of claim 15, wherein the processor is further configured to:
provide, to the large language model as an input prompt, a rationale request for the response to the particular query;
generate, using the large language model, rationale information that indicates a rationale for the response to the particular query in response to receiving the rationale request; and
present the rationale information via the user interface.

17. The device of claim 15, wherein the processor is further configured to provide, to the large language model as an input prompt, a response format of the particular query, wherein populating the particular field of the form corresponds to providing the response to the particular query according to the response format.

18. A non-transitory computer-readable medium comprising instructions that, when executed by a processor, cause the processor to perform operations comprising:
generating a text transcript of a real-time audio conversation;
generating, using a large language model, a response to a particular query on a form based on the text transcript, wherein an indication of the particular query and the text transcript are provided as input prompts to the large language model;
populating a particular field of the form based on the response to the particular query to generate a populated version of the form during the real-time audio conversation, wherein the particular field of the form is associated with the particular query; and
presenting the populated version of the form via a user interface.

19. The non-transitory computer-readable medium of claim 18, wherein the operations further comprise:
providing, to the large language model as an input prompt, a rationale request for the response to the particular query;
generating, using the large language model, rationale information that indicates a rationale for the response to the particular query in response to receiving the rationale request; and
presenting the rationale information via the user interface.

20. The non-transitory computer-readable medium of claim 19, wherein the rationale information comprises a particular portion of the text transcript, one or more inferences from the large language model based on the text transcript, or both.
